(19) United States
(12) Patent Application Publication
(10) Pub. No.: US 2007/0020441 A1
(43) Pub. Date: Jan. 25, 2007

(54) Core for a sandwich panel manufactured by deep drawing and a sandwich panel thereby

(75) Inventors: Byung Shik Kim, Seongnam-Si (KR); Bok Man Park, Yongin-Si (KR)

Correspondence Address: BIRCH STEWART KOLASCH & BIRCH, PO BOX 747, FALLS CHURCH, VA, 22040-0747, US

(73) Assignee: Hongseong Industrial Co., Ltd

(21) Appl. No.: 11/372,190

(22) Filed: Mar. 10, 2006

(30) Foreign Application Priority Data
Jul. 22, 2005 (KR) 10-2005-0066531
Sep. 2, 2005 (KR) 10-2005-0081671

(51) Int. Cl. B32B 3/28

(52) U.S. Cl. 428/180; 428/137; 428/174

(57) ABSTRACT

In a sandwich panel for decorating structure that the upper and lower adhesive layers 3,3′ are layered on the upper and lower surfaces of any one core 5 selected from honeycomb or corrugation cores, and the upper and lower metallic or non metallic plates 4,4′ are layered thereon and then the obtained object is hot-pressed to give a sandwich panel,

the present invention is characterized in that a metal plate 1 is pressed by a deep drawing process using a drawing die 100 consisted of a puncher 101 and a die 102, to form, in definite spaces, a great number of a kind of hollow part selected from conical, elliptic conical, or pyramidal hollow parts, having flat bottoms 9 on the metal plate 1, wherein the hollow parts 2 are formed in only any one surface of the upper or lower directions of the metal plate 1, or the upper and lower hollow parts 2, 2′ are formed alternately in both directions thereof, to give a deep drawing core 6, and that the upper and lower adhesive layers 3, 3′ are layered on the upper and lower surfaces of said obtained core 6 instead of said conventional core 5, and then said layered object is hot-pressed in accordance with the conventional process for preparating a sandwich panel to give a sandwich panel for decorating structure.

### CROSS REFERENCE TO RELATED DOCUMENTS

This application claims priority benefit of Korean Patent Application No. 10-2005-66531 field on Jul. 22, 2005 and Korean Patent Application No. 10-2005-81671 field on Sep. 2, 2005 to Byung-Shik Kim, which is hereby in corporated herein by reference.

### FIELD OF THE INVENTION

The present invention relates to a deep drawing core for a sandwich panel being manufactured by a deep drawing process and a sandwich panel for decorating a structure using it, more particularly to a deep drawing core obtained by forming a great number of a sort of hollow part selected from conical, elliptic conical, or pyramidal hollow parts in any one surface of the upper or lower directions of a metal plate, or in both surfaces thereof by a deep drawing process using a drawing die and a sandwich panel for decorating a structure manufactured in accordance with the conventional process for preparing a sandwich panel by using said obtained deep drawing core.

### DESCRIPTION OF THE PRIOR ART

Up to now, a sandwich panel for decorating a structure has been manufactured by layering adhesive layers 3,3′ on the upper and lower surfaces of any one of core selected from plastic sheet cores such as a foaming or unfoaming polyethylene sheet cores, a honeycomb core 5 as shown in FIG. 7 or a corrugation core 5 as shown in FIG. 8, by layering metal or nonmetal plates 4,4′ thereon, and then by hot-pressing the resulting layered object.

However in case that a sandwich panel is manufactured by a plastic sheet core, because the plastic sheet core is melted or burned easily by heat, in result, poisonous gases are generated, and thus they are not suitable as an incombustible construction material needed actually.

In case that the a sandwich panel is manufactured by using said honeycomb core or corrugation cores 5, when a certain part of the panel is cut in V type groove vertically or horizontally and then the grooved part is bent in order to carry out on bent part of a structure, due to structural defect of a core forming the sandwich panel the panel is not cut or bent precisely.

For examples, in case that the honeycomb core 5 is inserted in the sandwich panel, as shown in FIG. 7, because the upper and lower metal or nonmetal plates 4, 4′ and the core 5 are adhered by linear adherend 12 having weak adhesion, when the panel is cut in V type groove and the grooved part is bent the linear adherend 12 is damaged or separated easily. Accordingly function of the sandwich panel lowers. Also the sandwich panel having the honeycomb core 5 has fault that the cutting process is more difficult than that of flat plates owing to continuous honeycomb structure.

In case that the corrugation core 5 is inserted in the sandwich panel, as shown in FIG. 8, because bending portion of the core 5 and the upper and lower plates 4, 4′ also are adhered by linear adherend 12 their adhension is weak, accordingly when the panel is cut and bent the linear adherend 12 is separated easily and thereby the function of the panel is damaged and lowers.

Also because the core 5 corrugates, when the V type groove 8′ is formed in the sandwich panel having the corrugation core 5, since it corresponds to bent groove 10 of the corrugation core 5 supporting function of the upper and lower plate 4, 4′ by the core 5 lowers remarkably.

Accordingly its bent outer surface also is not smart or smooth.

Furthermore when the bending portion corresponds to hill 12 of the corrugation since the whole of the corrugated portion 11 are cut the bending portion and its outer surface are not smooth.

Therefore, the sandwich panel inserted the corrugation core 5 is not cut and not bent freely vertically or horizontally but the groove 8 is formed entirely only in vertical direction to the corrugation to give smooth outer surface by bending.

### SUMMARY OF INVENTION

The present invention is to solve the problems of conventional sandwich panels using honeycomb or corrugation cores.

Particularly, the object of present invention is to provide a core for a sandwich panel and a sandwich panel using the core that on the sandwich panel a V type groove can be cut and bent easily when the bent sandwich panel is made to carry out on bent portion of a structure.

More particularly, the present invention is characterized that any one kind of metal plate selected from metal plates such as an aluminum plate, a tin coating plate, a zinc coating plate, a stainless steel plate is pressed by means of a deep drawing process using a drawing die to form a great number of any one kind of hollow part selected from conical, elliptic conical, or pyramidal hollow parts such as trigonal tetragonal or octagonal pyramidal hollow parts having a flat bottom on the metal plate, wherein said hollow parts are sunk only in any one direction of the upper or lower directions of the metal plate, e.g. downwardly, or alternately downwardly and upwardly therefrom, to give a core for a sandwich panel, and using the resulting core a sandwich panel is manufactured by conventional process for preparation thereof.

### BRIEF DESCRIPTION OF THE DRAWINGS

FIG. 1a represents a plane view of a core for a sandwich panel in accordance with the present invention.

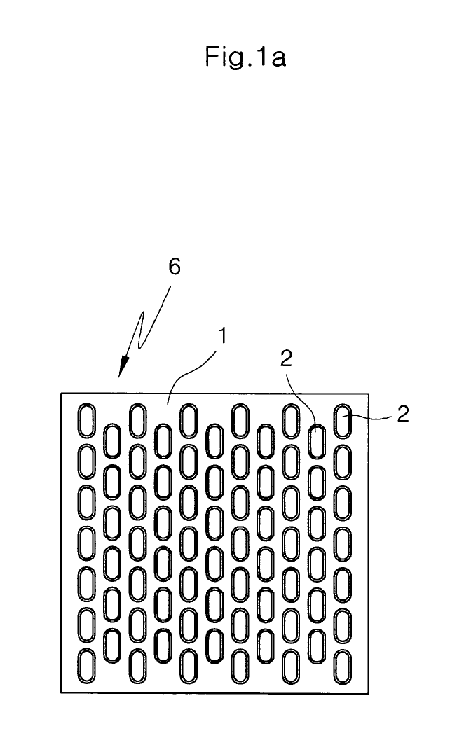

FIG. 1b represents a plane view of the other core for a sandwich panel in accordance with the present invention.

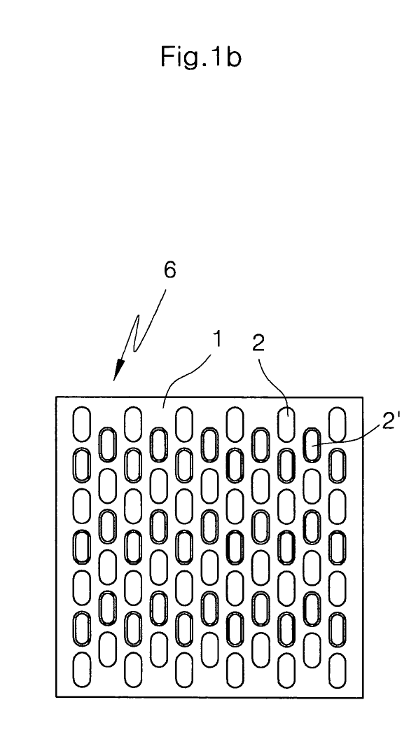

FIG. 2a represents a perspective view seen from the upside of a core for a sandwich panel in accordance with the present invention.

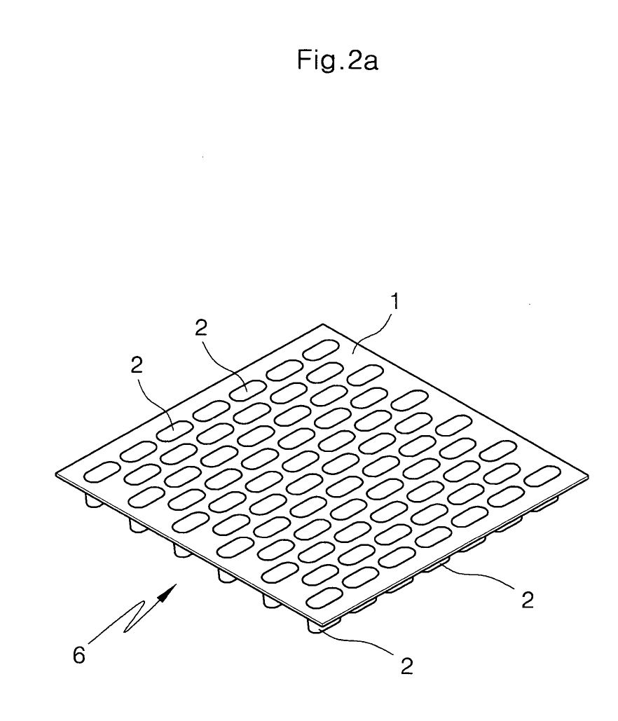

FIG. 2b represents a perspective view seen from the upside of the other core for a sandwich panel in accordance with the present invention.

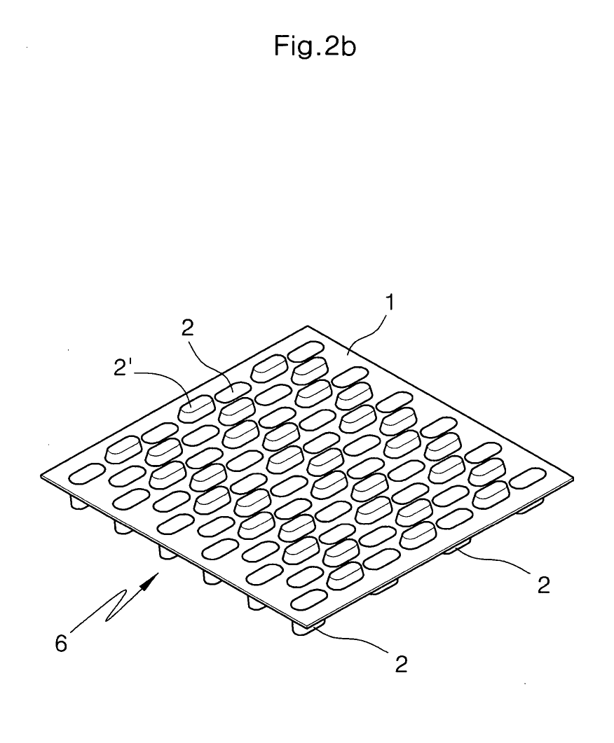

FIG. 3a represents a perspective view seen from the downside of Fig a.

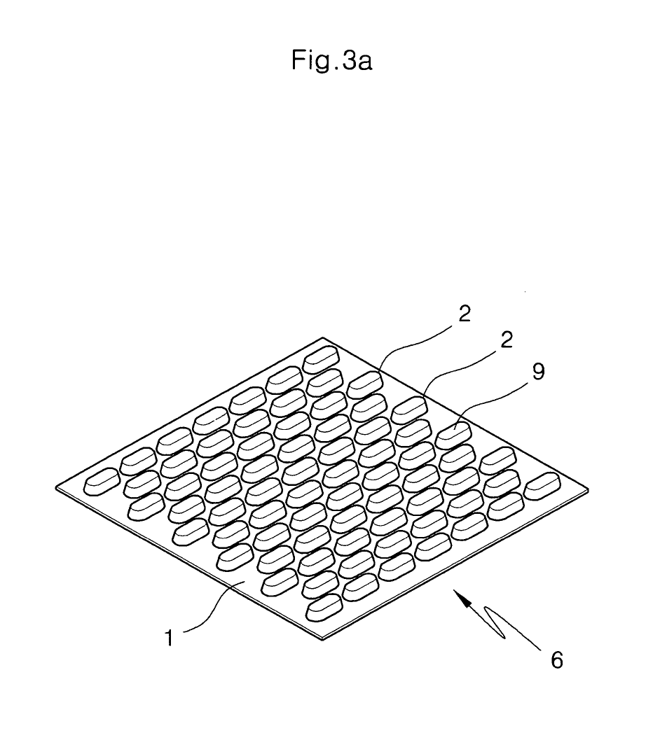

FIG. 3b represents a perspective view seen from the upside of Fig. b.

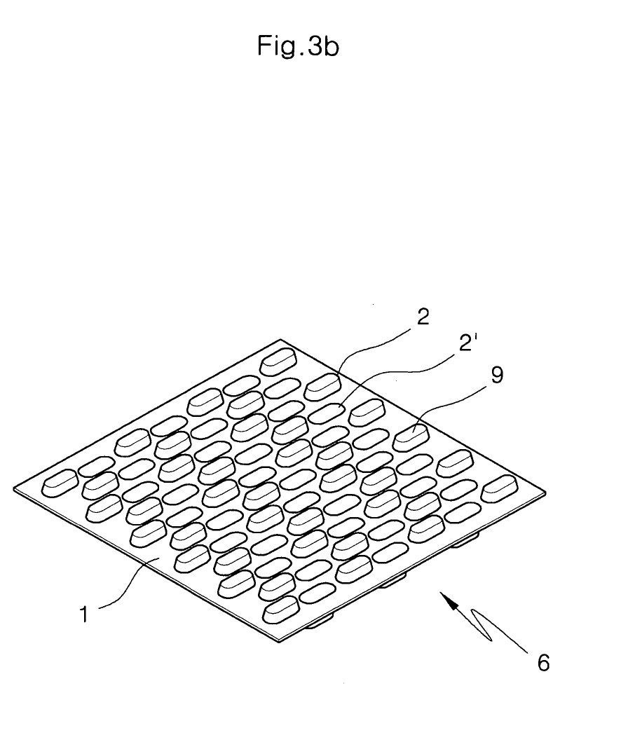

FIG. 4a represents a perspective view of a sandwich panel used a core for a sandwich panel in accordance with the present invention.

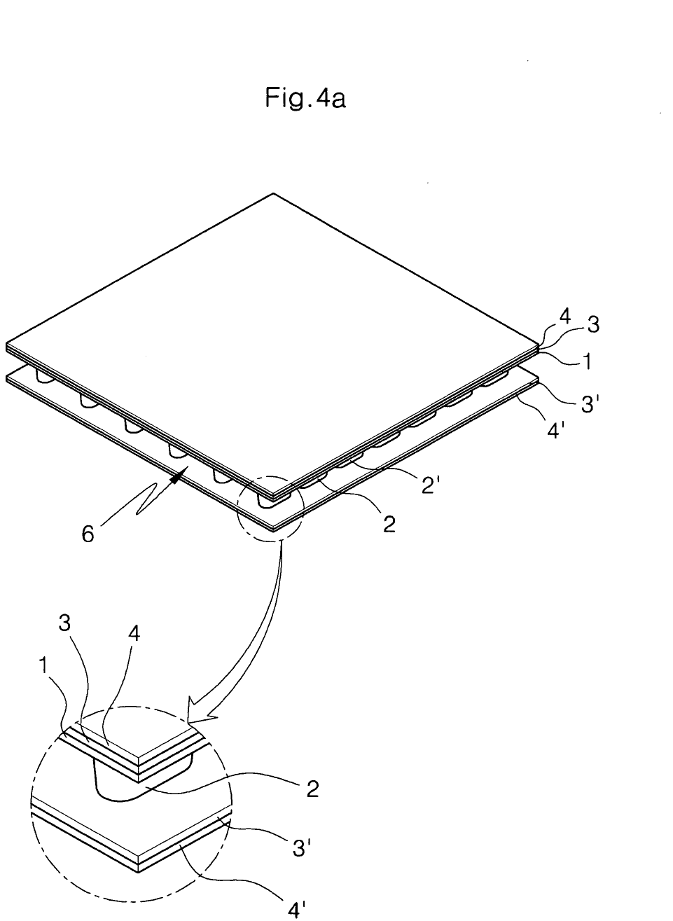

FIG. 4b represents a perspective view of a sandwich panel used other core for a sandwich panel in accordance with the present invention.

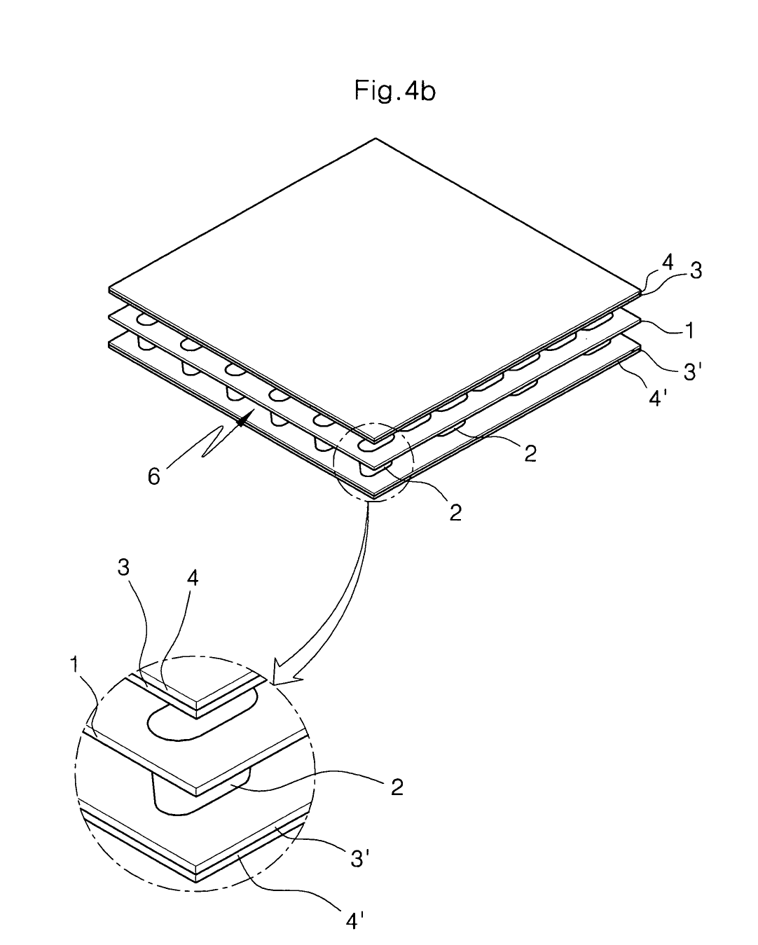

FIG. 5a represents a perspective view of a core for sandwich panel in accordance with the present invention formed vertical or horizontal grooves for bending.

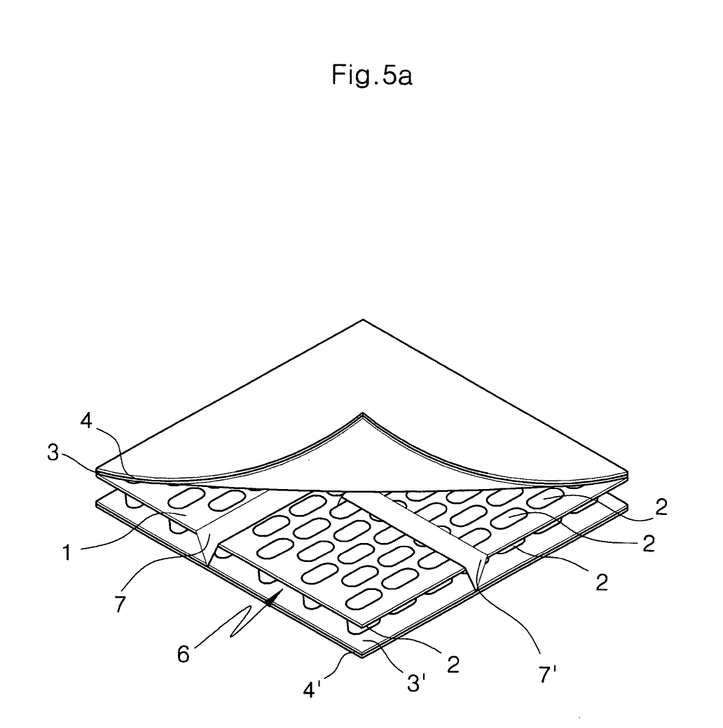

FIG. 5b represents a perspective view of other core for sandwich panel in accordance with the present invention formed vertical or horizontal grooves for bending.

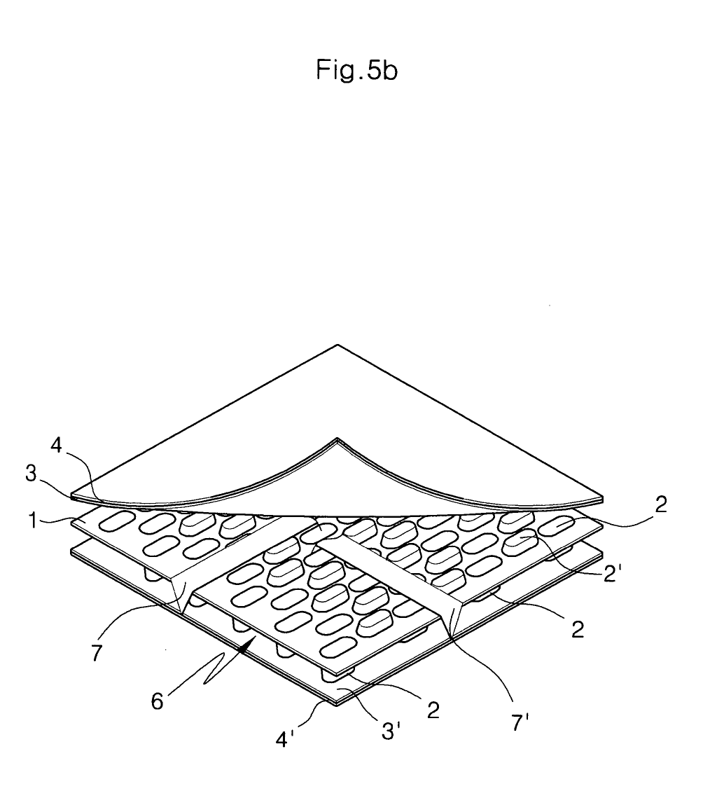

FIG. 6a represent a section view showing state molding a core by a drawing die for preparing a core in accordance with the present invention.

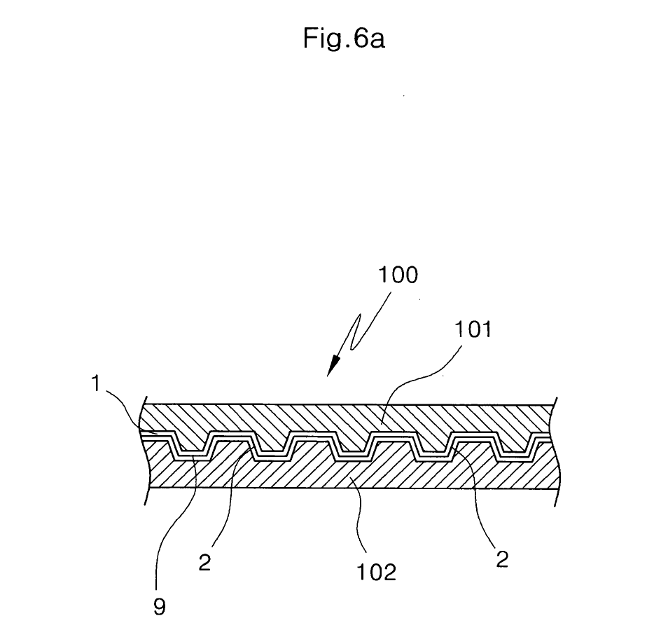

FIG. 6b represent a section view showing state molding other core by a drawing die for preparing a core in accordance with the present invention.

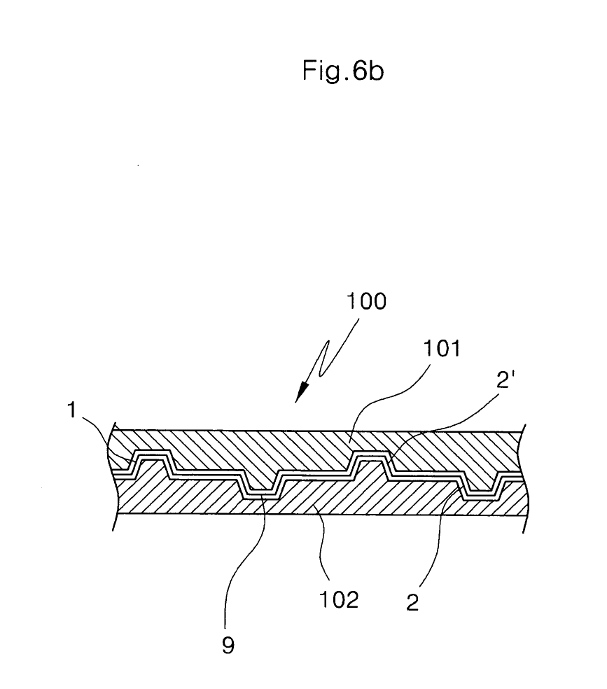

FIG. 7 represent a conventional sandwich panel inserted honeycomb core, formed vertical or horizontal grooves for bending.

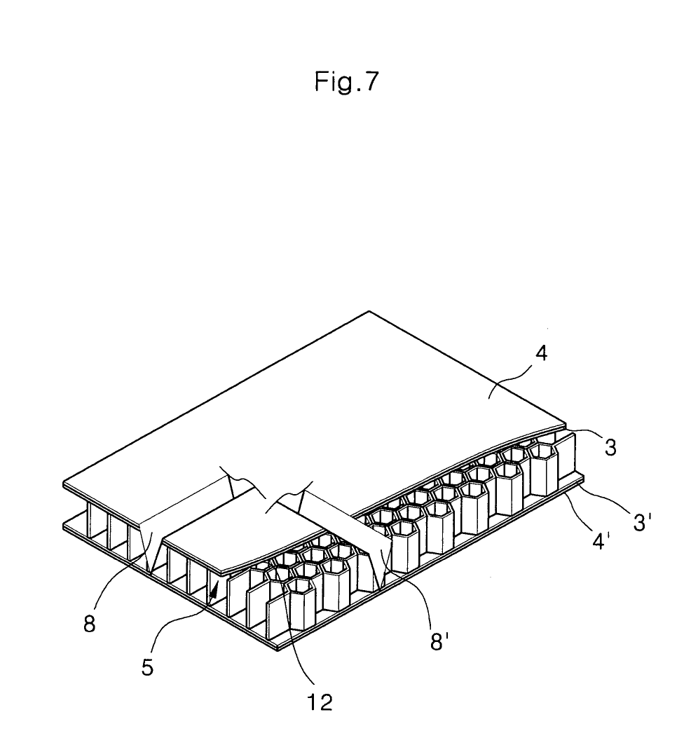

FIG. 8 represent a conventional sandwich panel inserted corrugation core, formed vertical or horizontal grooves for bending.

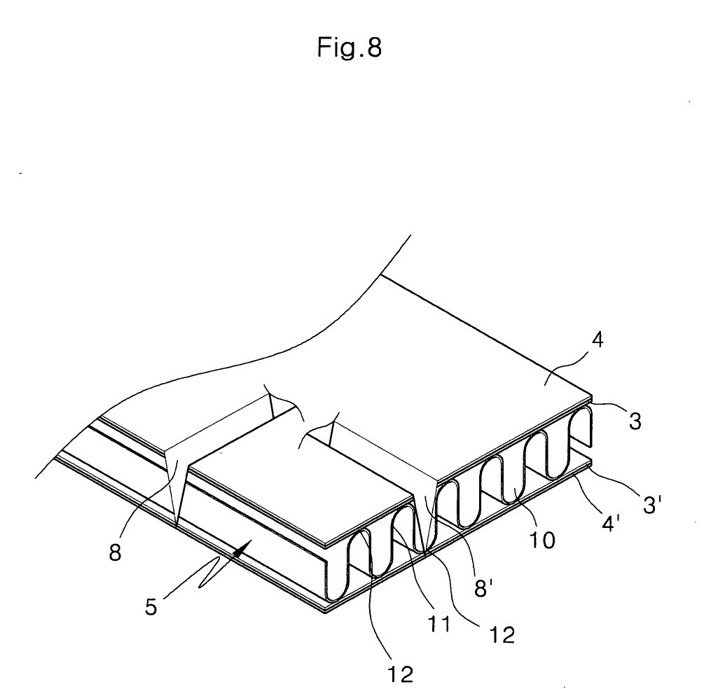

### DESCRIPTION OF PREFERRED EMBODIMENTS

Now, the present invention is described in detail referring to the drawings accompanying herein as follows;

In a sandwich panel for decorating a structure that the upper and lower adhesive layers 3, 3′ are layered on the upper and lower surfaces of any one of metal core 5 selected from honeycomb or corrugation cores, metal or nonmetal plates 4, 4′ are layered thereon and then the resulting object is hot-pressed, to give a sandwich panel,

a deep drawing core 6 and a sandwich panel using the resulting core 6 characterized in that any one kind of metal plate 1 selected from metal plates such as an aluminum plate, a tin coating plate, a zinc coating plate or a stainless steel plate is pressed by means of a deep drawing process using a drawing die 100 consisting of a puncher 101 and a die 102, to form a great number of any one kind of hollow part selected from various type of hollow parts such as conical, elliptic conical or pyramidal hollow parts, e, g, trigonal, tetragonal, or octagonal pyramidal hollow parts having a flat bottom 9 on the metal plate 1, wherein a great number of a kind of hollow part 2 are sunk, in a certain space, only in any one direction of the upper and lower surfaces of the metal plate 1, or a great number of a kind of the upper hollow part 2 and the lower hollow part 2′ are sunk in a certain space, alternately downwardly and upwardly, to give a core 6 for a sandwich panel, and that using said obtained deep drawing core 6 instead of said conventional core 5, on the upper and lower surfaces of said cores 6 any one kind of the upper and lower adhesive layers 3, 3′ selected from adhesives of a thermosetting resin such as an epoxy resin or thermoplastic resins such as a hot-melt type polyethylene, vinyl acetate, ethylene vinyl acetate copolymer resins are layered, then any one kind of plates 4, 4′ selected from metal plates such as aluminum, stainless steel or titanium plates, or nonmetal plates such as phenol, melamine, urea resin plates or a fibre glass reinforced plastic (FRP) plate are layered thereon and the resulting layered object is hot-pressed to give a sandwich panel.

Since in the above-mentioned deep drawing core 6 for the sandwich panel manufactured by the deep drawing process using the drawing die 100 the metal plate 1 is pressed by means of the deep drawing process using the drawing die 100, to form a great number of any one kind of hollow part selected from conical, elliptic conical or pyramidal hollow parts having the flat bottoms 9 on the metal plate 1, wherein a great number of a kind of hollow part 2 are sunk, definite space, only downwardly or upwardly, or a great number of a kind of the upper hollow part 2 and the lower hollow part 2′ are sunk, in a definite space, alternately downwardly and upwardly,

when the sandwich panel is manufactured using said core 6 since adherend of the core 6 and the metal or nonmetal plates 4, 4′ adhered thereon is broad the core 6 and the plates 4, 4′ are not separated and are kept hardly.

Furthermore, in the sandwich panels in accordance with the present invention since multiple hollow parts 2, 2′ are configured in vertical, horizontal and diagonal directions, in definite space, when on the sandwich panel of the present invention V type grooves 7 or 7′ are formed and they are bent to adhere on bent portions of a structure, the grooving process is achieved easily in all of directions such as vertical or horizontal, forms of the cut grooves 7 or 7′ are uniform.

What is claimed is:

1. A deep drawing core characterized in that a metal plate 1 is pressed by means of the deep drawing process using drawing die 100 consisting of a puncher 101 and a die 102 to form a great number of any one kind of hollow part selected from various type of hollow parts having flat bottoms 9 on the metal plate, wherein a great number of a kind of hollow part 2 are sunk, in a certain space, only in any one direction of the upper and lower surfaces of metal plate 1, or a great number of a kind of the upper hollow part 2 and the lower hollow part 2′, are sunk, in a certain space, alternately upwardly and downwardly, to give a core 6.

2. A sandwich panel using a deep drawing core characterized in that according to the conventional process for preparing the sandwich panel, the upper and lower adhesive layers 3, 3′ made from any one of resin selected from thermosetting or thermoplastic resins are layered on the upper and lower surfaces of said core 6 in accordance with claim 1, the upper and lower plates 4, 4′ made of any one of plate selected from metal or nonmetal plates are layered on said adhesive layers 3, 3′ and then the resulting object is hot-pressed to give a sandwich panel.

3. A deep drawing core in accordance with claim 1, wherein said metal plate 1 is any one of metal plate selected from aluminum, tin coating, zinc coating and stainless steel plates.

4. A deep drawing core in accordance with claim 1, wherein the various type of hollow parts 2, 2′ are any one of hollow part selected from a conical, an elliptic conical hollow parts or pyramidal hollow parts such as a trigonal, a tetragonal or an octagonal pyramidal hollow parts.

5. A sandwich panel using a deep drawing core in accordance with claim 2, wherein said thermosetting resin is an epoxy resin and thermoplastic resin is any one of resin selected from a hot-melt type polyethylene, a vinyl acetate, or an ethylene vinyl acetate copolymer resins.

6. A sandwich panel using a deep drawing core in accordance with claim 2, wherein said metal plate is any one of plate selected from aluminum, stainless steel or titanium plates.

7. A sandwich panel using a deep drawing core in accordance with claim 2, wherein said nonmetal plate is any one of plate selected from phenol, melamine, urea resin plates, or fiberglass reinforced plastic plates.
